(19) United States
(12) Patent Application Publication
(10) Pub. No.: US 2014/0012451 A1
(43) Pub. Date: Jan. 9, 2014

(54) VEHICULAR CONTROL DEVICE

(71) Applicant: Takashi Amano, Susono-shi (JP)

(72) Inventor: Takashi Amano, Susono-shi (JP)

(73) Assignee: Toyota Jidosha Kabushiki Kaisha, Toyota-shi, Aichi-ken (JP)

(21) Appl. No.: 14/006,864

(22) PCT Filed: Mar. 24, 2011
(86) PCT No.: PCT/JP2011/057154

§ 371 Date: Sep. 23, 2013

(51) Int. Cl. B60W 20/00; B60W 10/08; B60W 10/06

(52) U.S. Cl. CPC B60W 20/108; B60W 10/06; B60W 10/08; B60W 2600/00; Y10S 903/93
USPC 701/22; 180/65.265; 903/930

(57) ABSTRACT

An ECU is mounted in a vehicle including an in-cylinder injection type engine having an EGR device and a motor. The ECU calculates vehicular requested power Preq and the ECU calculates a requested engine operating point OPreq based on the vehicular requested power Preq, and if the requested engine operating point OPreq falls within an EGR range, the ECU sets the requested engine operating point OPreq exactly as a commanded engine operating point OPcom, whereas if the requested engine operating point OPreq falls within a non-EGR range, the ECU corrects the requested engine operating point OPreq to fall within the EGR range and sets the corrected engine operating point as the commanded engine operating point OPcom. The ECU then controls the engine and the motor so that an actual engine operating point coincides with the commanded engine operating point OPcom while satisfying the vehicular requested power Preq.

### TECHNICAL FIELD

The present invention relates to controlling a vehicle including an engine having an exhaust gas recirculation device and a motor connected to the engine.

### BACKGROUND ART

A recent engine is equipped with an exhaust gas recirculation device (hereinafter also referred to as an “EGR device”) recirculating a portion of exhaust gas to an intake air flow path for better fuel economy and the like.

Japanese Patent Laying-Open No. 11-223138 (PTD 1) discloses that when a vehicle whose travelling state is controlled by an output of an in-cylinder injection type engine having an EGR device is required to reduce the engine's output, with the engine driven in a predetermined state, it limits exhaust gas recirculation.

### CITATION LIST

### Patent Document

PTD 1: Japanese Patent Laying-Open No. 11-223138

PTD 2: Japanese Patent Laying-Open No. 2009-262758

PTD 3: Japanese Patent Laying-Open No. 2010-53716

PTD 4: Japanese Patent Laying-Open No. 2010-174859

PTD 5: Japanese Patent Laying-Open No. 2010-222978

### SUMMARY OF INVENTION

### Technical Problem

However, PTD 1 does not specifically discuss how the EGR device is controlled in a vehicle including an engine having the EGR device and a motor (a so-called hybrid vehicle).

The present invention has been made to overcome the above disadvantage, and it contemplates improving the fuel economy of a vehicle including an engine having an EGR device and a motor.

### Solution to Problem

The present invention provides a control device controlling a vehicle equipped with an engine equipped with a recirculation device for recirculating a portion of exhaust gas to an intake air path, and a motor cooperating with the engine to generate vehicular driving force. The recirculation device is operated when the engine is operated in a recirculation range. The recirculation device is stopped when the engine is operated in a non-recirculation range smaller in torque than the recirculation range. The control device includes: a calculation unit that calculates vehicular requested power requested for the vehicle; and a control unit that controls the engine and the motor to operate the engine in the recirculation range While satisfying the vehicular requested power.

Preferably, the engine has an injection valve to inject fuel directly into a cylinder.

Preferably, the control unit controls an actual engine operating point determined by an actual speed of the engine and an actual torque of the engine to fail within the recirculation range.

Preferably, the control unit calculates a requested engine operating point based on the vehicular requested power, and if the requested engine operating point falls within the recirculation range, the control unit sets the requested engine operating point as the actual engine operating point, whereas if the requested engine operating point does not fall within the recirculation range, the control unit moves the requested engine operating point toward higher torque to fall within the recirculation range to provide a corrected engine operating point and sets the corrected engine operating point as the actual engine operating point.

Preferably, the corrected engine operating point provides slower engine speed and larger torque than and is equal in power to the requested engine operating point.

Preferably, the corrected engine operating point is equal in engine speed to and provides larger power than the requested engine operating point.

Preferably, the corrected engine operating point provides slower engine speed, larger torque, and larger power than the requested engine operating point.

Preferably, when the corrected engine operating point is increased in power to he larger than the requested engine operating point, the control unit decreases the motor in power as the corrected engine operating point increases in power so that the vehicular requested power is satisfied.

### Advantageous Effects of Invention

The present invention can thus improve the fuel economy of a vehicle including an engine having an EGR device and a motor.

### BRIEF DESCRIPTION OF DRAWINGS

FIG. 1 is a first diagram showing a structure of a vehicle.

FIG. 2 is a diagram schematically showing a configuration of an engine.

FIG. 3 is a functional block diagram of an ECU.

FIG. 4 is a first diagram showing a technique to set a commanded engine operating point OPcom.

FIG. 5 is a first diagram showing a manner of controlling an engine, a first MG, and a second MG.

FIG. 6 is a flowchart showing a procedure of a process of the ECU.

FIG. 7 is a second diagram showing a technique to set commanded engine operating point OPcom.

FIG. 8 is a third diagram showing a technique to set commanded engine operating point OPcom.

FIG. 9 is a second diagram showing a manner of controlling the engine, the first MG, and the second MG.

FIG. 10 is a fourth diagram showing a technique to set commanded engine operating point OPcom.

FIG. 11 is a second diagram showing a structure of a vehicle.

### DESCRIPTION OF EMBODIMENTS

Hereinafter reference will be made to the drawings to describe the present invention in embodiments. In the following description, identical components are identically denoted. Their names and functions are also identical. Accordingly, they will not be described repeatedly in detail.

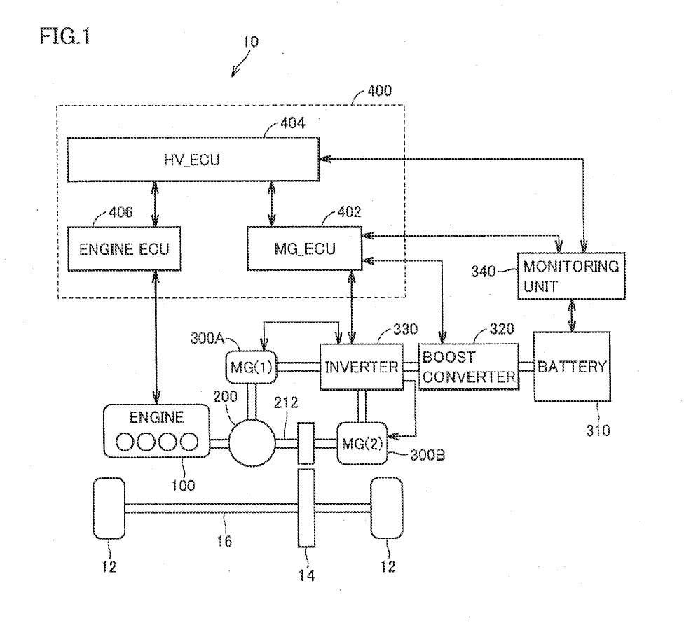

FIG. 1 shows a structure of a vehicle 10 having a control device mounted therein in the present embodiment. Vehicle 10 is a hybrid vehicle which travels by the motive power of at least one of an engine 100 and a second motor generator (hereinafter the “second MG”) 300B.

Vehicle 10, including engine 100 and second MG 300B, further includes a first motor generator (hereinafter the “first MG”) 300A, a motive power split device 200, a driving wheel 12, a speed reducer 14, a battery 310, a boost converter 320, an inverter 330, an engine ECU 406, an MG_ECU 402, an HV_ECU 404, and the like.

Motive power split device 200 is configured of a planetary gear including a sun gear, a pinion gear, a carrier, and a ring gear. The pinion gear is engaged with the sun gear and the ring gear. The carrier supports the pinion gear rotatably and is coupled with a crankshaft of engine 100. The sun gear is coupled with a rotary shaft of first MG 300A. The ring gear is coupled with a rotary shaft of second MG 300B and speed reducer 14 via an output shaft 212. Engine 100, first MG 300A, and second MG 300B thus coupled via motive power split device 200 configured of the planetary gear exhibit engine speed Ne, first MG rotation speed Nm1, and second MG rotation speed Nm2 having a relationship connected by a straight line in a nomographic chart (see FIG. 5 described hereinafter).

Speed reducer 14 transmits the motive power generated in engine 100, first MG 300A, and second MG 300B to driving wheel 12, and transmits the driving of driving wheel 12 to engine 100, first MG 300A, and second MG 300B.

Battery 310 stores electric power for driving first MG 300A and second MG 300B. Boost converter 320 performs voltage conversion between battery 310 and inverter 330. Inverter 330 controls a current while converting the direct current of battery 310 and the alternating current of first MG 300A and second MG 300B.

Engine ECU 406 controls the operational state of engine 100. MG_ECU 402 operates in accordance with a state of vehicle 10 to control first MG 300A, second MG 300B, inverter 330, how battery 310 is charged and discharged, and the like. HV_ECU 404 manages and controls engine ECU 406, MG_ECU 402 and the like mutually to generally control a hybrid system so that vehicle 10 can be operated most efficiently. Note that while FIG. 1 shows each ECU discretely configured, two or more ECU may be integrated. For example, as indicated in FIG. 1 by a dotted line, integrating MG_ECU 402, HV_ECU 404, and engine ECU 406 together as ECU 400 is one example thereof In the following description, MG_ECU 402, HV_ECU 404, and engine ECU 406 are not distinguished and instead indicated as ECU 400.

ECU 400 receives signals from a vehicular speed sensor, an accelerator pedal position sensor, a throttle angle sensor, an engine speed sensor, a first MG rotation speed sensor, a second MG rotation speed sensor (all not shown), a monitoring unit 340 that monitors the state of battery 310, and the like.

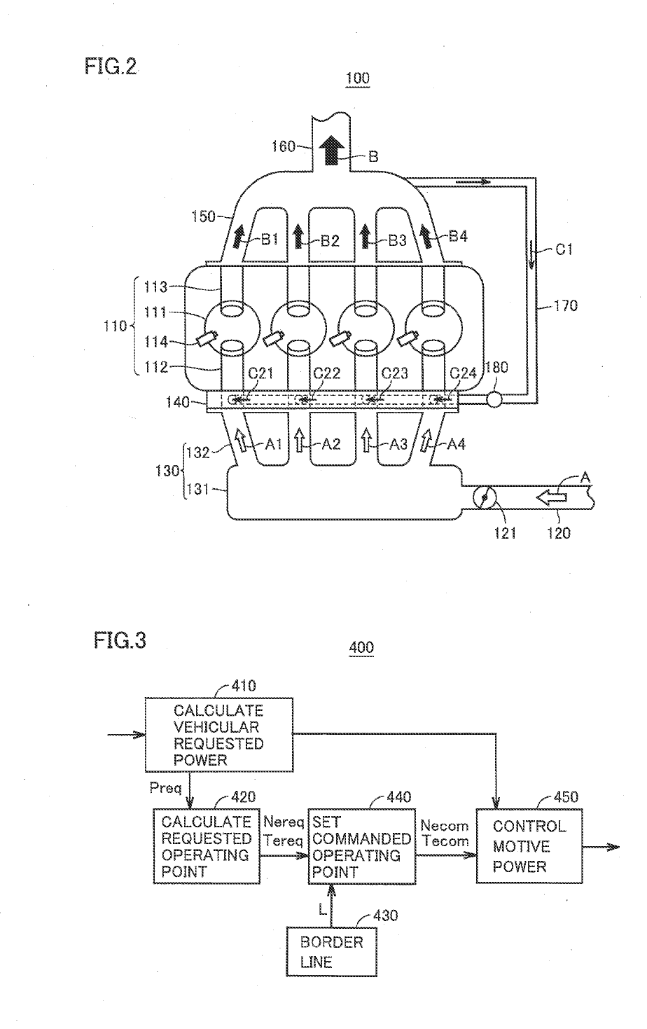

FIG. 2 is a diagram schematically showing a configuration of engine 100. Engine 100 includes an engine body 110, an intake pipe 120, a surge tank equipped intake manifold 130, a delivery chamber 140, an exhaust manifold 150, an exhaust pipe 160, and an EGR pipe 170.

Engine body 110 includes a plurality of cylinders 111 (in FIG. 1, four cylinders), and a plurality of intake ports 112, a plurality of exhaust ports 113 and a plurality of in-cylinder injectors 114 associated with the plurality of cylinders 111, respectively. In engine 100, the air introduced through an air cleaner (not shown) flows through intake pipe 120 (see an arrow A) into a surge tank 131 in intake manifold 130 equipped with the surge tank. Intake pipe 1.20 is connected to surge tank 131 at a portion, which is provided with an electronic throttle valve 121 controlled by a control signal issued from ECU 400. An amount of air introduced into surge tank 131 is adjusted depending on an amount by which electronic throttle valve 121 is operated (i.e., a throttle angle).

Surge tank equipped intake manifold 130 is provided between intake pipe 120 and engine body 110. Surge tank equipped intake manifold 130 is surge tank 131 and intake manifold 132 integrally provided. Note that surge tank 131 and intake manifold 132 may be provided separately. The air in surge tank 131 is distributed to each intake port 112 of engine body 110 via intake manifold 132 (see arrows A1-A4). The air distributed to each intake port 112 is introduced into each cylinder 111.

Each in-cylinder injector 114 injects fuel directly in each cylinder 111. In other words, engine 100 is a so-called in-cylinder injection type engine. The fuel injected in each cylinder 111 is mixed with air, ignited by an igniter (not shown), and thus combusted. The combustion provides exhaust gas, which is discharged to each exhaust port 113. Exhaust port 113 receives the exhaust gas, which is in turn collected by exhaust manifold 150 and delivered to exhaust pipe 160 (see arrows B and B1-B4).

Engine 100 has an exhaust gas recirculation (EGR) device mounted therein to recirculate a portion of exhaust gas to an intake air flow path. The EGR device can be operated to achieve better fuel economy. The EGR device is configured of EGR pipe 170 and an EGR valve 180. A portion of exhaust gas is returned to the intake side via EGR pipe 170 and delivery chamber 140 (see arrows C1 and C21-C24). EGR pipe 170 is provided with EGR valve 180 controlled by a control signal issued from ECU 400.

Vehicle 10 is thus a hybrid vehicle including a powertrain structure including in-cylinder injection type engine 100 having EGR device and second MG 300B cooperating with engine 100 to generate vehicular driving force. In such a hybrid vehicle, the EGR device is operated only in a range in which a requested load for the vehicle is high in view of minimizing deposits on in-cylinder injector 114. More specifically, in-cylinder injector 114 has a nozzle in a cylinder and the nozzle has deposits thereon depending on how fuel is combusted, and when the vehicle is required to bear a large load, the engine's load is also increased and accordingly a large amount of fuel is injected through the nozzle, and the deposits on the nozzle can be blown away by the injected fuel. On the other hand, when the vehicle is only required to bear a small load, the engine's load is also decreased and accordingly a small amount of fuel is injected through the nozzle, and it is thus difficult to blow away the deposits on the nozzle by the injected fuel. When the engine's load is small, operating the EGR device to recirculate exhaust gas produces tar in the cylinder from uncombusted hydrocarbon contained in exhaust gas and will induce further deposits. Accordingly, the EGR device is operated only for a range in which the engine's load is large, and the EGR device is stopped for a range in which the engine's load is small (hereinafter, a large-load range in which the EGR device is operated will be referred to as an “EGR range”, and a small-load range in which the EGR device is stopped will be referred to as a “non-EGR range”). Accordingly, when engine 100 is operated in the non-EGR range, the effect of the improvement in fuel economy by EGR is no longer obtained.

Accordingly in the present embodiment ECU 400 controls engine 100, first MG 300A, and second MG 300B so that engine 100 is operated in the EGR range while vehicular requested power is satisfied. This point is the most characteristic point of the present invention.

FIG. 3 is a functional block diagram of ECU 400. Each functional block shown in FIG. 3 may be implemented by hardware or software.

ECU 400 includes a vehicular requested power calculation unit 410, a requested operating point calculation unit 420, a border line storage unit 430, a commanded operating point setting unit 440, and a motive power control unit 450.

Vehicular requested power calculation unit 410 calculates vehicular requested power Preq based on an amount by which the user operates the accelerator pedal or the like.

Requested operating point calculation unit 420 calculates a requested engine operating point OPreq based on vehicular requested power Preq. An engine operating point is an index which indicates an operational status of engine 100 determined by engine speed Ne and engine torque Te. Requested engine operating point OPreq is an engine operating point satisfying vehicular requested power Preq. Accordingly, calculating requested engine operating point OPreq is in effect calculating requested engine speed Nereq and requested engine torque Tereq.

Border line storage unit 430 stores a border line L of the EGR range and the non-EGR range.

Commanded operating point setting unit 440 sets a commanded engine operating point OPcom (commanded engine speed Necom and commanded engine torque Tecom) based on requested engine operating point OPreq and border line L. Specifically, if requested engine operating point OPreq exceeds border line L and falls within the EGR range, commanded operating point setting unit 440 sets requested engine operating point OPreq exactly as commanded engine operating point OPcom. In contrast, if requested engine operating point OPreq does not exceed border line L and falls within the non-EGR range, commanded operating point setting unit 440 corrects requested engine operating point OPreq to fall within the EGR range and sets the corrected engine operating point as commanded engine operating point OPcom.

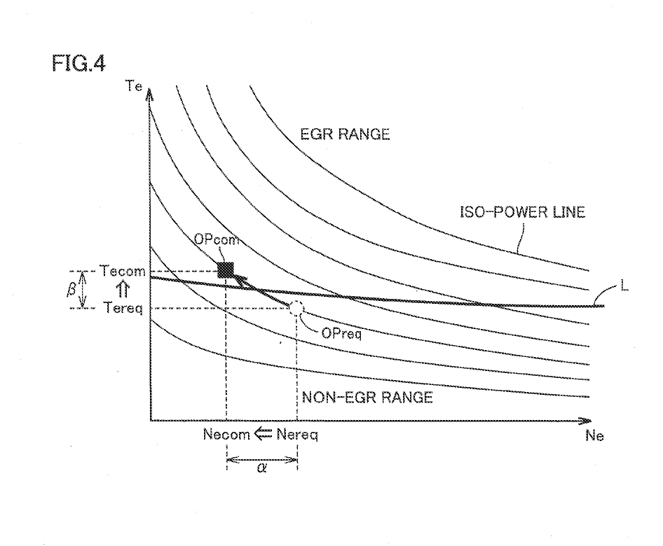

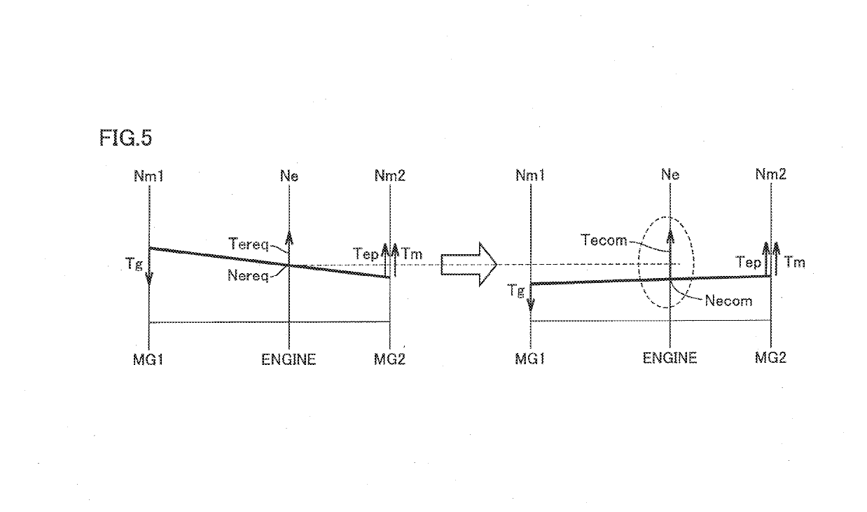

FIG. 4 is a diagram for illustrating a technique to set commanded engine operating point OPcom (or correct requested engine operating point OPreq). As shown in FIG. 4, when requested engine operating point OPreq falls within the non-EGR range, commanded operating point setting unit 440 moves requested engine operating point OPreq on the same power line as requested engine operating point OPreq toward higher torque until it exceeds border line L, and commanded operating point setting unit 440 sets the moved engine operating point as commanded engine operating point OPcom. More specifically, commanded operating point setting unit 440 sets requested engine speed Nereq minus predetermined speed a as commanded engine speed Necom, and sets requested engine torque Tereq plus predetermined torque β as commanded engine torque Tecom, as shown in FIG. 4. Herein, Nereq×Tereq=Necom×Tecom is established, and commanded engine operating point OPcom will be the same power as requested engine operating point OPreq and also fall within the EGR range.

Again with reference to FIG. 3, motive power control unit 450 controls engine 100, first MG 300A, and second MG 300B so that an actual engine operating point coincides with commanded engine operating point OPcom while vehicular requested power is satisfied.

FIG. 5 represents on a nomographic chart how engine 100, first MG 300A, and second MG 300B are controlled. In FIG. 5, “Tg” represents first MG torque, “Tm” represents second MG torque, and “Tep” represents a torque transmitted from engine 100 via motive power split device 200 to output shaft 212 (hereinafter referred to as “engine-direct torque”).

As has been described above, if requested engine operating point OPreq falls within the non-EGR range, commanded engine operating point OPcom is set so that Tecom>Tereq and Necom<Nereq (see the white arrow in FIG. 5). At the time, Nereq×Tereq=Necom×Tecom is established and commanded engine operating point OPcom provides a value of power equal to that of requested engine operating point OPreq. Thus, vehicular requested power can be satisfied without varying the power of second MG 300B.

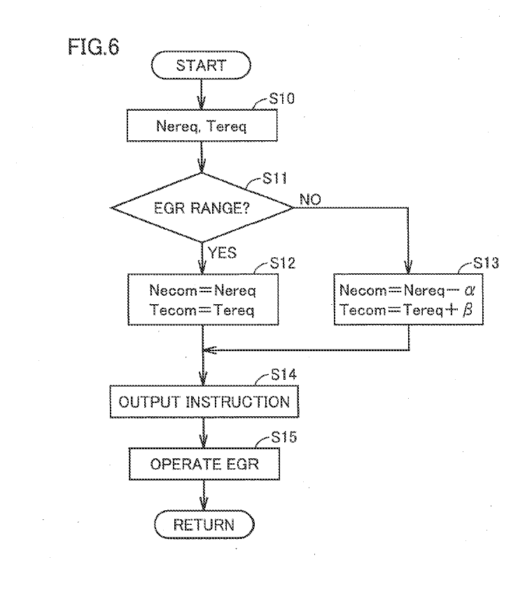

FIG. 6 is a flowchart showing a procedure of a process of ECU 400 to implement the function described above.

In Step (hereinafter “S”) 10, ECU 400 calculates requested engine operating point OPreq (i.e., requested engine speed Nereq and requested engine torque Tereq) based on vehicular requested power Preq.

In S11, ECU 400 determines whether requested engine operating point OPreq falls within the EGR range (i.e., exceeds border L).

If requested engine operating point OPreq falls within the EGR range (YES at S11), ECU 400 proceeds to S12 to set requested engine operating point OPreq exactly as commanded engine operating point OPcom. In other words, Necom=Nereq and Tecom=Tereq are set.

If requested engine operating point OPreq does not fall within the EGR range (NO at S11), ECU 400 proceeds to 513 to set as commanded engine operating point OPcom requested engine operating point OPreq moved toward higher torque to fall within the EGR range. In other words, Necom=Nereq−α and Tecom=Tereq+β are set (see FIG. 4).

In S14, ECU 400 outputs an instruction to engine 100, first MG 300A, and second MG 300B to cause an actual engine operating point to coincide with commanded engine operating point OPcom while satisfying vehicular requested power.

In S15, ECU 400 operates the EGR device.

Thus in the present embodiment when a vehicle including an in-cylinder injection type engine having an EGR device and a motor is not requested to output large power (i.e., when a requested engine operating point falls within the non-EGR range), ECU 400 controls the engine and the motor to keep the EGR device in operation while satisfying vehicular requested power. The user's request can be satisfied and better fuel economy can also be achieved.

First Exemplary Variation

In the above described embodiment, requested engine operating point OPreq is corrected without particularly considering motive power transmission, thermal efficiency and the like (see FIG. 4). Motive power transmission, thermal efficiency and the like may be considered in correcting requested engine operating point OPreq.

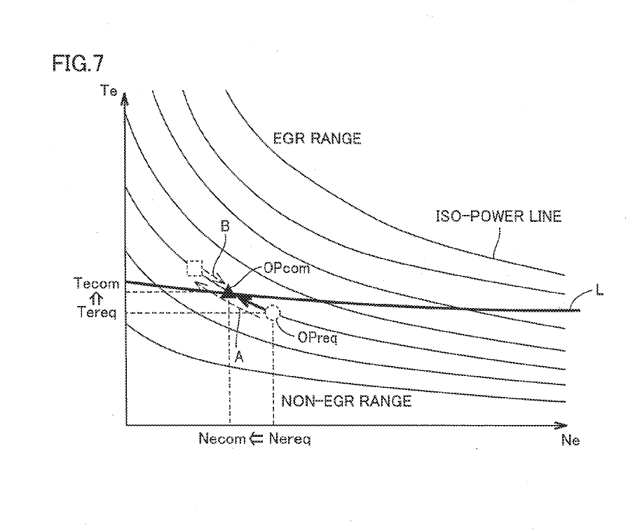

FIG. 7 is a diagram for illustrating a technique to set commanded engine operating point OPcom (or correct requested engine operating point OPreq). As shown in FIG. 7, if requested engine operating point OPreq falls within the non-EGR range, requested engine operating point OPreq may be moved with the same power to fall within the EGR range (see an arrow A in FIG. 7) and furthermore, a map or the like with motive power transmission, thermal efficiency and the like considered may be used to move the requested engine operating point within the EGR range to an operating point allowing optimal motive power transmission, optimal thermal efficiency and the like (see an arrow B in FIG. 7) and set the moved engine operating point as commanded engine operating point OPcom. This can keep the EGR device in operation, and also achieve optimal motive power transmission, optimal thermal efficiency and the like.

Second Exemplary Variation

In the above described embodiment, when commanded engine operating point OPcom is compared with requested engine operating point OPreq, the former provides slower engine speed, larger torque, and equal power (see FIG. 4). Alternatively, the loader may be set to provide equal engine speed and larger torque (i.e., to provide larger power).

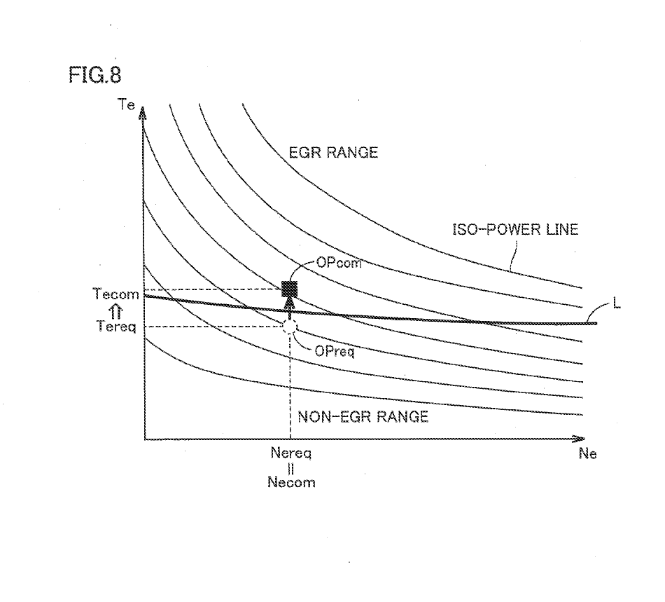

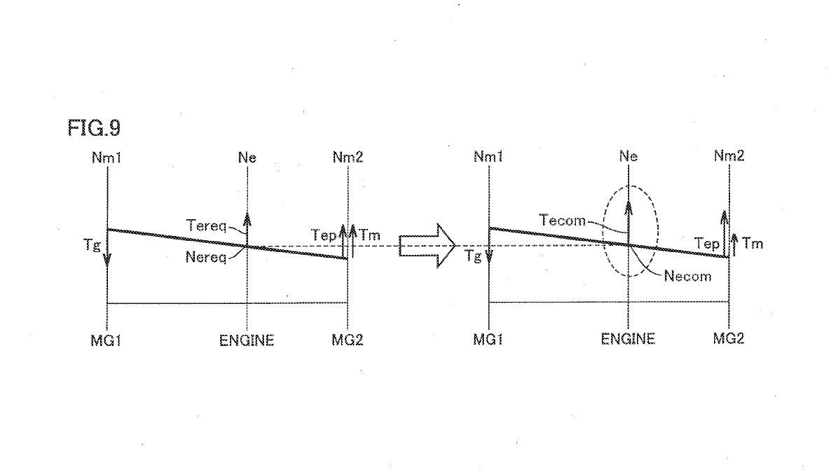

FIG. 8 is a diagram for illustrating a technique to set commanded engine operating point OPcom (or correct requested engine operating point OPreq). As shown in FIG. 8, when requested engine operating point OPreq falls within the non-EGR range, requested engine operating point OPreq may be moved to an operating point providing larger power than requested engine operating point OPreq and also falling within the EGR range and the moved engine operating point may be set as commanded engine operating point OPcom. In doing so, commanded engine speed Necom is requested engine speed Nereq. This eliminates the necessity of changing engine speed, and the example if an actual engine operating point falls within the non-EGR range, the actual engine operating point can early be moved to the EGR range.

FIG. 9 represents on a nomographic chart how engine 100, first MG 300A, and second MG 300B are controlled in the present exemplary variation. As has been described above, in the present exemplary variation, commanded engine operating point OPcom is set to provide Necom=Nereq and Tecom>Tereq, and accordingly, commanded engine operating point OPcom increases in power to be larger than requested engine operating point OPreq and the power transmitted from engine 100 via motive power split device 200 to output shaft 212 (hereinafter also referred to as “engine-direct power”) also increases. Accordingly, ECU 400 decreases second MG torque Tm by an amount corresponding to an amount of the engine-direct power that is increased. This can keep the EGR device in operation and also satisfy vehicular requested power without varying vehicular power in total.

Third Exemplary Variation

In the first exemplary variation, commanded engine operating point OPcom is set with an optimal operating point considered, and in the second exemplary variation, commanded engine operating point OPcom is increased in power to be larger than requested engine operating point OPreq. The first and second exemplary variations may be combined to increase commanded engine operating point OPcom in power to be larger than requested engine operating point OPreq with an optimal operating point considered.

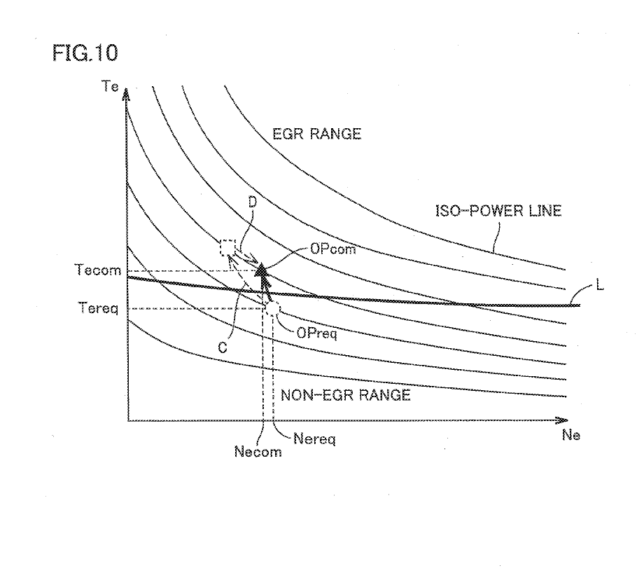

FIG. 10 is a diagram for illustrating a technique to set commanded engine operating point OPcom (or correct requested engine operating point OPreq) in the present exemplary variation. As shown in FIG. 10, when requested engine operating point OPreq falls within the non-EGR range, requested engine operating point OPreq may be moved to an operating point providing larger power than requested engine operating point OPreq and also falling within the EGR range (see an arrow C in FIG. 10) and furthermore, a map or the like with motive power transmission, thermal efficiency and the like considered may be used to move the moved engine operating point within the EGR range to an operating point providing motive power transmission, thermal efficiency and the like optimally (see an arrow D in FIG. 10), and set the moved engine operating point as commanded engine operating point OPcom. This can also keep the EGR device in operation and also achieve optimal motive power transmission, optimal thermal efficiency and the like, as well as the first exemplary variation.

Furthermore, the present exemplary variation, as well as the second exemplary variation, increases commanded engine operating point OPcom in power to be larger than requested engine operating point OPreq. Accordingly, decreasing second MG torque Tin by an amount corresponding to an amount of the engine-direct power that is increased suffices, as has been described above with reference to FIG. 9.

While the present invention has been described, in an embodiment of and its first to third exemplary variations, the present invention is not limited in application to engine 100 shown in FIG. 2; rather it is applicable to engines having the EGR device (in-cylinder injection type engines in particular).

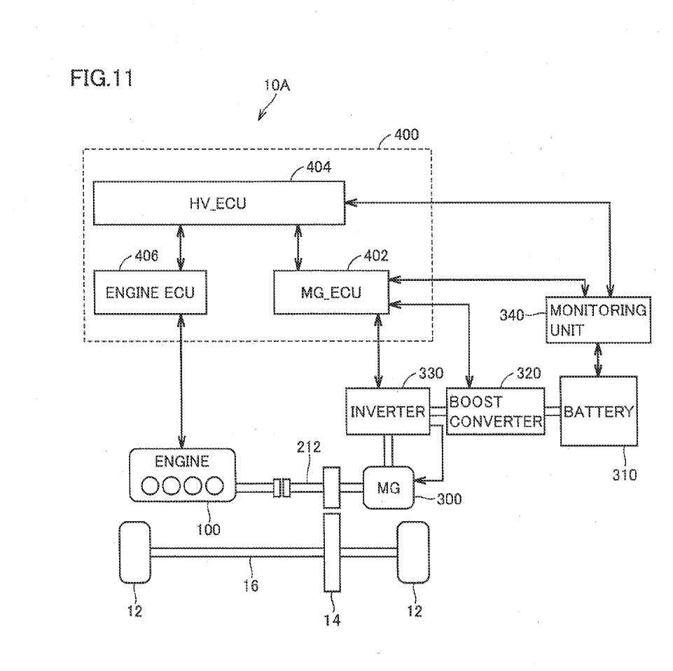

Furthermore the present invention is not limited in application to vehicle 10 shown in FIG. 1; rather it is applicable to hybrid vehicles including an engine having the EGR device and a motor. For example, as shown in FIG. 11, it may be a vehicle 10A including in-cylinder injection type engine 100 having the EGR device and a single motor generator 300. Such vehicle 10A allows engine load rate adjustment to be absorbed by motor generator 300, and accordingly, allows a larger degree of freedom in controlling an engine operating point or an engine load rate to maintain the EGR range, and the present invention can be more easily applied thereto.

It should be understood that the embodiments disclosed herein are illustrative and non-restrictive in any respect. The scope of the present invention is defined by the terms of the claims, rather than by the foregoing description, and is intended to include any modifications within the scope and meaning equivalent to the terms of the claims.

### REFERENCE SIGNS LIST

10, 10A: vehicle; 12: driving wheel; 14: speed reducer; 100: engine; 110: engine body; 111: cylinder; 112: intake port; 113: exhaust port; 114: in-cylinder injector; 120; intake pipe; 121: electronic throttle valve; 130: surge tank equipped intake manifold; 131: surge tank; 132: intake manifold; 140; delivery chamber; 150: exhaust manifold; 160: exhaust pipe; 170: EGR pipe; 180: EGR valve; 200: motive power split device; 212: output shaft; 300: motor generator; 310: battery; 320: boost converter; 330: inverter; 340: monitoring unit; 400: ECU; 410: vehicular requested power calculation unit; 420: requested operating point calculation unit; 430: border line storage unit; 440: commanded operating point setting unit; 450: motive power control unit.

1. A control device for a vehicle equipped with an engine equipped with a recirculation device for recirculating a portion of exhaust gas to an intake air path, and a motor cooperating with said engine to generate vehicular driving force, said recirculation device being operated when said engine is operated in a recirculation range, said recirculation device being stopped when said engine is operated in a non-recirculation range smaller in torque than said recirculation range, the control device comprising:
a calculation unit that calculates vehicular requested power requested for said vehicle; and
a control unit that controls said engine and said motor to operate said engine in said recirculation range while satisfying said vehicular requested power.

2. The control device for a vehicle according to claim 1, wherein said engine has an injection valve to inject fuel directly into a cylinder.

3. The control device for a vehicle according to claim 2, wherein said control unit controls an actual engine operating point determined by an actual speed of said engine and an actual torque of said engine to fall within said recirculation range.

4. The control device for a vehicle according to claim 3, wherein said control unit calculates a requested engine operating point based on said vehicular requested power, and if said requested engine operating point falls within said recirculation range, said control unit sets said requested engine operating point as said actual engine operating point, whereas if said requested engine operating point does not fall within said recirculation range, said control unit moves said requested engine operating point toward higher torque to fall within said recirculation range to provide a corrected engine operating point and sets said corrected engine operating point as said actual engine operating point.

5. The control device for a vehicle according to claim 4, wherein said corrected engine operating point provides slower engine speed and larger torque than and is equal in power to said requested engine operating point.

6. The control device for a vehicle according to claim 4, wherein said corrected engine operating point is equal in engine speed to and provides larger power than said requested engine operating point.

7. The control device for a vehicle according to claim 4, wherein said corrected engine operating point provides slower engine speed, larger torque, and larger power than said requested engine operating point.

8. The control device for a vehicle according to claim 6, wherein when said corrected engine operating point is increased in power to be larger than said requested engine operating point, said control unit decreases said motor in power as said corrected engine operating point increases in power so that said vehicular requested power is satisfied.
